(19) United States
(12) Patent Application Publication
(10) Pub. No.: US 2023/0029759 A1
(43) Pub. Date: Feb. 2, 2023

(54) METHOD OF CLASSIFYING UTTERANCE EMOTION IN DIALOGUE USING WORD-LEVEL EMOTION EMBEDDING BASED ON SEMI-SUPERVISED LEARNING AND LONG SHORT-TERM MEMORY MODEL

(71) Applicant: KOREA ADVANCED INSTITUTE OF SCIENCE AND TECHNOLOGY, Daejeon (KR)

(72) Inventors: Hojin CHOI, Daejeon (KR); Youngjun LEE, Daejeon (KR)

(73) Assignee: KOREA ADVANCED INSTITUTE OF SCIENCE AND TECHNOLOGY, Daejeon (KR)

(21) Appl. No.: 17/789,088

(22) PCT Filed: Feb. 12, 2020
(86) PCT No.: PCT/KR2020/001931

§ 371 Date: Jun. 24, 2022

(30) Foreign Application Priority Data
Dec. 27, 2019 (KR) 10-2019-0176837

(51) Int. Cl. G10L 15/16; G10L 25/63

(52) U.S. Cl. CPC G10L 15/16; G10L 25/63

(57) ABSTRACT

A method of classifying emotions of utterances in a dialogue using word-level emotion embedding based on semi-supervised learning and a long short-term memory (LSTM) model includes embedding word-level emotion by tagging an emotion for each of words in utterances of input dialogue data with reference to a word-emotion association lexicon in which basic emotions are tagged for words for learning; extracting an emotion value of the utterances input; and classifying emotions of the utterances in consideration of change of emotion in the dialogue made in a messenger client, based on the LSTM model, using extracted emotion values of the utterances as input values of the LSTM model. The present invention can appropriately classify emotions by recognizing a change in emotion in a dialogue made in natural language.

### BACKGROUND

### 1. Technical Field

The present invention relates to classification of utterance emotion in a messenger dialogue, and more particularly, a method for classifying the emotions of respective utterances in a dialogue using word-level emotion embedding and deep learning.

### 2. Description of the Related Art

Chat services have been used for a long time for a user to exchange messages with other users on the Internet using a messenger program installed in communicable computing devices of users through devices such as Internet devices and a server computer. Later, with the development of mobile phones and mobile devices, the spatial limitations of Internet access were overcome, and the chat service becomes available wherever there is a device that can access the Internet. When users send and receive messages within a chat room, the emotion of users may change. Since the content of the previous message may have a great influence on the change of emotion, the emotion of each utterance within a chat is different.

For a long time, humans have been conducting a lot of research so that machines can understand human emotions. However, it may be difficult for a machine to determine what kind of emotion a human has when entering a message with only the sentences. As users send and receive messages, their emotions may change due to previous messages. In addition, although a message has a positive meaning when only the message is considered, the message may have a negative meaning when considering the situation in a chat. For example, when only the message ‘Oh, it feels good’ is considered, the machine recognizes the message as a feeling of joy. However, if the situation within the chat was negative, then the machine's recognition of the emotion of joy could be the wrong result.

Conventionally, techniques for classifying emotions in messengers or texts allow machines to classify human emotions by mainly building a pattern dictionary. Korean Patent Application Publication Nos. 10-2004-0106960 (Prior Art 1) and 10-2015-0080112 (Prior Art 2) are known as relevant prior art.

Prior Art 1 classifies human emotions contained in natural language input dialogue sentences input by humans. In the Prior Art 1, emotional verbs and emotional nouns are used to classify latent emotions in natural language sentences. Emotional nouns and emotional verbs are expressed as three-dimensional vectors. In addition, since the degrees of emotions expressed in natural language sentences may be different from each other, an adverb of degree is used. In addition, in order to understand the relationship between the word expressing emotion and its surrounding words, an emotion-associated vocabulary lexicon is created. And in order to grasp emotions of idioms or idiomatic phrases, the pattern database (DB) in which the idiom or idiomatic expression information is stored is used. However, there are the following problems.

First, since the combinations of sentences that can be composed of natural language are infinite, it is impossible to create an emotional relational lexicon and pattern DB for all sentences. In addition, an error may occur in emotion classification unless the input sentence corresponds to the emotion relation lexicon and pattern DB.

Second, it is difficult to classify the emotions in consideration of the changes in the emotions in the chat because the emotions of messages are classified using the established patterns and vocabulary.

Third, there is a problem in that it is difficult to grasp the proper meaning of emotional nouns and emotional verbs expressed as three-dimensional vectors.

Prior Art 2 also classifies emotions in everyday messenger dialogues. To this end, patterns of dialogue contents are formed and patterns necessary for emotion classification are extracted. Machine learning is performed using the extracted patterns as input. However, this method also has a problem.

First, since the combinations of sentences that can be composed of natural language are infinite, the types of patterns to be constructed are also infinite. Therefore, there is a problem in that it is difficult to make a pattern for all sentences.

Second, since everyday messengers consist of various types of contents, an error in emotion classification may occur if a sentence that does not correspond to the established pattern is inputted.

Third, it is difficult to classify emotions in consideration of changes in emotions in chat only with patterns.

As described above, the prior art has problems in that it is difficult to consider changes in emotions in chat, and patterns must be prepared according to all dialogue contents. Therefore, it is necessary to develop a method of classifying emotions in consideration of changes in emotions.

### SUMMARY

It is an object of the present invention to provide a method for classifying emotions of utterances in a dialogue by using semi-supervised learning based word-level emotion embedding and a long short-term memory (LSTM) model.

Objects of the present invention are not limited to the above-described ones, and may be variously expanded without departing from the spirit and scope of the present invention.

According to embodiments for achieving the objects of the present invention, a method of classifying emotions of utterances in a dialogue using word-level emotion embedding based on semi-supervised learning and a long short-term memory (LSTM) model is implanted as a computer readable program and executable by a processor of a computing apparatus. The method comprises embedding, in the computing apparatus, word-level emotion by tagging an emotion for each of words in utterances of input dialogue data with reference to a word-emotion association lexicon in which basic emotions are tagged for words for learning; extracting, in the computing apparatus, an emotion value of the utterances input; and classifying, in the computing apparatus, emotions of the utterances in consideration of change of emotion in the dialogue made in a messenger client, based on the LSTM model, using extracted emotion values of the utterances as input values of the LSTM model.

In exemplary embodiments, the embedding word-level emotion may include: tagging an emotion value of each word in the utterances made of natural language with reference to the word-emotion association lexicon, to construct data with a lot of a pair of a word and an emotion corresponding to the word for learning word-level emotion embedding; extracting a meaningful vector value that a word has in a the dialogue; and extracting a meaningful emotion vector value that the word has in an utterance.

In exemplary embodiments, the word-emotion association lexicon may include six emotions as the basic emotion: anger, fear, disgust, happiness, sadness, and surprise.

In exemplary embodiments, the meaningful vector value of the word may be an encoded vector value obtained by performing a weight operation on a word vector expressed by one-hot encoding and a weight matrix.

In exemplary embodiments, the ‘meaningful emotion vector value of the word’ may be obtained by performing a weight operation on the vector value encoded in extracting a vector value for the word and a weight matrix, and a value of the weight matrix may be adjusted by comparing a vector value extracted through the weight operation with an emotion value to be expected.

In exemplary embodiments, the ‘extracting an emotion value of the utterances input’ may be to extract word-level emotion vector value through word-level emotion embedding for words constituting the utterances, and calculate an emotion value of the utterances by summing the extracted values.

In exemplary embodiments, the ‘classifying emotions of the utterances in consideration of change of emotion in the dialogue’ may be to classify the emotions of utterances in the dialogue by using a sum of the emotion values of the utterances in the dialogue extracted in the extracting an utterance-level emotion value (S200) as an input to the LSTM model, and perform a comparison operation between values output from the LSTM model and an emotion value to be expected through a softmax function.

In exemplary embodiments, the input dialogue data may be data input to the computing apparatus acting as a server computer through the messenger client generated by a client computing apparatus.

According to exemplary embodiments of the present invention, it is possible to classify the utterance emotions in dialogues such as chats by using word-level emotion embedding based on the semi-supervised learning and the LSTM model. This technology can recognize changes in emotions in natural language dialogues and classify emotions appropriately.

### BRIEF DESCRIPTION OF THE DRAWINGS

FIG. 1 schematically illustrates a configuration of a system for performing a method of classifying utterance emotions in a dialogue using semi-supervised learning-based word-level emotion embedding and the LSTM model according to an exemplary embodiment of the present invention.

FIG. 2 illustrates a model for classifying utterance emotions in a dialogue according to an exemplary embodiment of the present invention.

FIG. 3 illustrates architecture of the word-level emotion embedding unit shown in FIG. 2.

FIG. 4 is a flowchart illustrating a method of classifying utterance emotions in a dialogue using the semi-supervised learning-based word-level emotion embedding and the LSTM model according to an exemplary embodiment of the present invention.

FIG. 5 is a detailed flowchart of a step of a word-level emotion embedding according to an exemplary embodiment of the present invention.

FIG. 6 is a detailed flowchart of a step of extracting an utterance-level emotion value according to an exemplary embodiment of the present invention.

FIG. 7 is a diagram illustrating a method of classifying utterance emotions in a dialogue based on the LSTM model according to an exemplary embodiment of the present invention.

### DETAILED DESCRIPTION OF THE EMBODIMENTS

The detailed description of the present invention that follows refers to the accompanying drawings, which show by way of illustration specific embodiments in which the invention may be practiced. These embodiments are described in sufficient detail to enable those skilled in the art to practice the present invention. It should be understood that the various embodiments of the present invention are different but need not be mutually exclusive. For example, certain shapes, structures, and characteristics described herein may be implemented in other embodiments with respect to one embodiment without departing from the spirit and scope of the invention. In addition, it should be understood that the location or arrangement of individual components within each disclosed embodiment may be changed without departing from the spirit and scope of the present invention. Accordingly, the following detailed description is not intended to be taken in a limiting sense, and the scope of the present invention, if properly described, is limited only by the appended claims, along with all scope equivalents to those claimed. Like reference numerals in the drawings refer to the same or similar functions throughout the various aspects.

Hereinafter, a learning method for classifying the emotions of utterances in a dialogue using the semi-supervised learning-based word-level emotion embedding according to an exemplary embodiment of the present invention will be described with reference to the accompanying drawings.

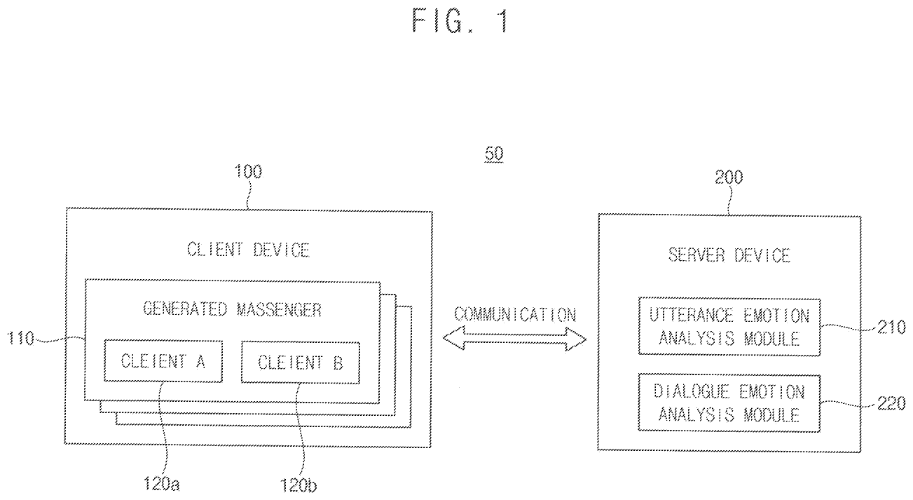

FIG. 1 schematically shows a configuration of a system 50 according to an embodiment of the present invention. The system 50 is a system for performing a method of classifying utterance emotions in a dialogue using word-level emotion embedding based on the semi-supervised learning and the LSTM model according to an exemplary embodiment of the present invention. The system 50 may include a client computer device 100, and a server computer device 200. Briefly describing, the client computer device 100 may be a device for generating dialogue data for dialogue emotion classification, and providing the generated dialogue data to the server computer device 200 as input data. The server computer device 200 is a device to receive the input data from the client computer device 100 and process the dialogue emotion classification.

The client computer device 100 may be a device that has a computing function for receiving human dialogues and converting them into digital data, a communication function capable of communicating with an external computing device such as the server computer device 200 through a communication network, etc. As the representative example, the client computer device 100 may include a smart phone device, a mobile communication terminal (cellular phone), a portable computer, a tablet, a personal computer device, etc., but is not necessarily limited thereto. There is no limitation on the type of computing device as long as it is capable of performing the above functions.

The server computer device 200 may be implemented as a computer device for a server. A plurality of client computer devices 100 may access the server computer device 200 through wired communication and/or wireless communication. The server computer device 200 may be a computing device that performs, in response to requests from the client computer devices 100, a function of receiving digital data transmitted by the client computer devices 100, a function of processing the received data to classify emotions of the dialogue, etc. and further performs a function of returning a processing result to the corresponding client computer device 100, if necessary.

The system 50 may be, for example, an instant messenger system that relays dialogues between multiple users in real time. Examples of commercialized instant messenger systems may include the KakaoTalk messenger system and the Line messenger system, etc. The client computer device 100 may include a generated messenger 110. The messenger 110 may be implemented as a program readable by the client computer device 100. For example, in the case of the KakaoTalk messenger system, the messenger 110 may be included as a part of the KakaoTalk messenger application program. The client computer device 100 may be a smartphone terminal used by KakaoTalk users, and the messenger 110 may be provided as some functional module included in the KakaoTalk messenger. The messenger 110 program may be made into an executable file. The executable file may be executed in the client computer device 100 to cause a processor of the client computer device 100 to create a space for dialogue between users, and to act as a messenger so that the users of a plurality of client computer devices 100 participating in the dialogue space can send and receive dialogues between them.

The server computer device 200 may receive dialogues from the generated messenger 110 of the connected client computer devices 100, and classify emotions of the utterances in the input dialogues. Specifically, the server computer device 200 may support a communication connection so that the client computer devices 100 can access itself, and create a messenger room between the client computer devices 100 connected through the server computer device 200 so that the client computer devices 100 can exchange dialogue messages between them. In addition, the server computer device 200 may receive dialogues between the client computer devices 100 as input data and perform a process of classifying emotions of the dialogues.

To this end, the server computer device 200 may include an utterance emotion analysis module 210 and a dialogue emotion analysis module 220. Each of the utterance emotion analysis module 210 and the dialogue emotion analysis module 220 may be implemented as a computer program readable by a computer device. The programs of the utterance emotion analysis module 210 and the dialogue emotion analysis module 220 may be made into executable files. These executable files may be executed on a computer device functioning as the server computer device 200.

The utterance emotion classification module 210 may be a module for extracting an emotion vector value of the received sentence. The dialogue emotion classification module 220 may be a module for classifying the emotions of utterances by recognizing changes in emotions in dialogues made in the generated messenger 110.

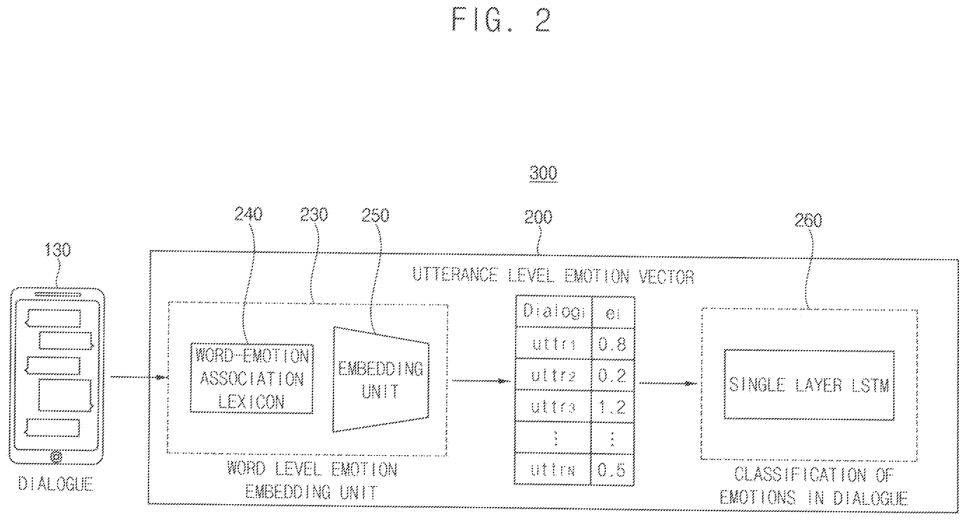

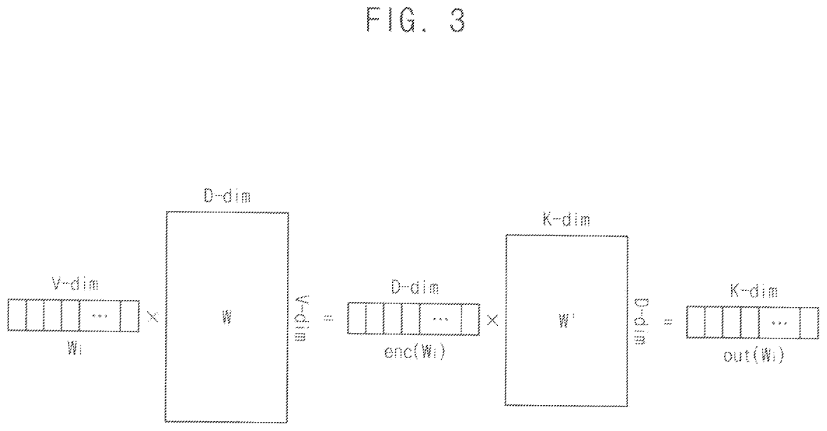

In FIG. 2, a model 300 for classifying the utterance emotions in a dialogue is illustrated according to an exemplary embodiment of the present invention. In FIG. 3, architecture of the word-level emotion embedding unit 230 shown in FIG. 2 is illustrated an exemplary embodiment of the present invention.

Referring to FIG. 2, the smart phone 130 is presented as an example of the client computer device 100. The word-level emotion embedding unit 230 and a single layer LSTM unit 260 may be executed in the server computer device 200.

The emotion classification model 300 shown in FIG. 2 is a model in which the server computer device 200 receives dialogue data as input data from the smartphone 130, which is an example of the client computer device 100, and processes emotion classification. The emotion classification model 300 is based on the following three items. The first is word-level emotion embedding. That is, since the word in the same utterance may have similar emotions, it is necessary to embed emotions as word-level based on the semi-supervised learning. The second is extraction (expression) of utterance-level emotion values. That is, emotion vector values which represent utterance's emotion may be obtained through the element-wise summation operator. The third is classification of utterance's emotions within dialogue. A single-layer LSTM may be trained to classify the emotion of utterance in dialogue.

In the training process, two main parts of the emotion classification model, that is, word-level emotion embedding and emotion classification in dialogue may be trained separately. In the inference process, the dialogue is fed into the emotion classification model to classify the emotion of utterance in dialogue. An utterance is composed of words. To classify an emotion of utterance, it is required to understand emotions of words consist of utterances. According to the utterance, even the same word may have different emotions. For example, in the following sentences “I love you” and “I hate you”, the word “you” which is in “I love you” is closer to “joy” among the Ekman's six basic emotions. But, the word “you” which is in “I hate you” is closer to “anger” or “disgust” among the Ekman's six basic emotions. Therefore, it is necessary to consider that words in the same utterance have similar emotions.

According to an exemplary embodiment of the present invention, classifying the emotion of an utterance in dialogue may be performed based on semi-supervised word-level emotion embedding. The main idea of the present invention is that co-occurrence words in the same utterance have similar emotions based on the distributional hypothesis. Therefore, the emotion classification model 300 according to the exemplary embodiment needs to express the word emotion as a vector. Before classifying emotions in dialogue, a modified version of the skip-gram model may be trained to obtain a word-level emotion vector. Unlike the existing model, the emotion classification model 300 may be trained by the semi-supervised learning.

For semi-supervised learning of word-level emotion vectors, labeled data may be required. For labeling emotions for each word, a word-emotion association lexicon 240 may be needed. An example of the word-emotion association lexicon 240 may be the National Research Council (NRC) emotion lexicon. The NRC emotion lexicon includes a list of English words and their associations labeled with eight basic emotions and two sentiments. Through semi-supervised learning, words that are not labeled in the NRC emotion lexicon may be expressed as emotions in the vector space. In an exemplary embodiment of the present invention, only a part of the emotions used in the NRC emotion lexicon may be utilized. For example, only 7 basic emotions (Ekman's 6 basic emotions+neutral) or 8 basic emotions (Ekman's 6 basic emotions+neutral and non-neutral) may be considered in the word-emotion association lexicon 240. The word-emotion association lexicon 240 according to an exemplary embodiment may include, for example, Ekman's six basic emotions, namely, anger, fear, disgust, happiness, sadness, and surprise as basic human emotions. To obtain an emotion of a certain utterance, these emotion vectors may be added to the utterance. Then, a single-layer LSTM-based classification network may be trained in the dialogue.

As shown in FIG. 3, an input word wᵢ fed into the word-level emotion embedding unit 250 is a word in an input utterance uttrᵢ of length n, and may be expressed as Equation (1).

uttrᵢ=w₁,w₂, . . . ,wₙ (1)

The input word wᵢ is encoded using 1-of-V encoding, where V is a size of the vocabulary. A weight matrix W has a V×D dimension, W∈R^{V×D}. The input word wᵢ is projected by the weight matrix W. The encoded vector enc(wᵢ) with D dimensions represents 1-of-V encoding vector wᵢ as a continuous vector. The result of calculating enc(wᵢ) with the weight matrix W′ is an output vector out(wᵢ). The weight matrix W′ has a D×K dimensions, W∈R^{D×K}, where K is the number of emotion label. Then, the predicted output vector out(wᵢ) may be trained through a comparison operation with an expected output vector.

For training this embedding model, pairs of the input and the expected output may be made. Since this architecture is a slight variant of the skip-gram model, the maximum distance of the words may be chosen based on the central word. Only the central word which is in the word-emotion association lexicon 240, for example, NRC Emotion Lexicon may be selected. After selecting the central word, the context words may be labeled with the same emotion of the central word. Through the semi-supervise learning, the emotion of word may be represented as a continuous vector in vector space. For example, if the word “beautiful” is not in the word-emotion association lexicon 240, the word “beautiful” will be represented as the emotion “joy” in the continuous vector space.

Emotion may be expressed in the utterance-level. From the pre-trained vector, an emotion of an utterance may be obtained. Let an i^{th} utterance of length n is represented as Equation (1) where n is not fixed variable. Let e(wᵢ) is the pre-trained vector which was applied to the word-level emotion embedding. The emotion of the i^{th} sentence is represented as follows.

e(uttrᵢ)=e(w₁)+e(w₂)+ . . . +e(wₙ) (2)

Here, + is an element-wise summation operator. As mentioned above, all of utterances do not have the same length. For this reason, the summation operator may be used instead of the concatenation operator. Emotion vectors e(uttrᵢ) obtained using Equation (2) may be used to classify emotions in dialogue.

The emotions in a dialogue may be classified as follows. A single layer LSTM-based classification network may be trained on utterance-level emotion vectors obtained from a semi-supervised neural language model. As described above, it is important to consider the contextual information in dialogue, such as the emotion flow. In the exemplary embodiment, the emotion flow is regarded as a sequential data. Thus, recurrent neural network (RNN) architecture may be adopted in the classification model. Let the dialogue consists of several utterances. It is represented as follows.

dialogue=uttr₁,uttr₂, . . . ,uttr_{c} (3)

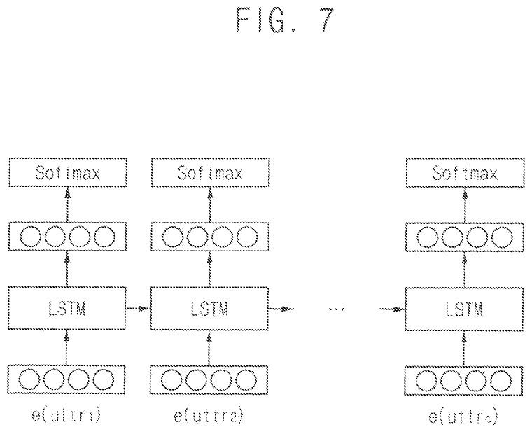

Here, C is not fixed. As shown in FIG. 7, an input e(uttrᵢ) provided to the single layer LSTM 260 at time step t is emotion vectors. At time step t, the predicted output vector and the expected output vector may be computed with a non-linear function such as softmax. Here, the softmax function is a function to normalize all input values to values between 0 and 1 as outputs, where the sum of the output values is always 1.

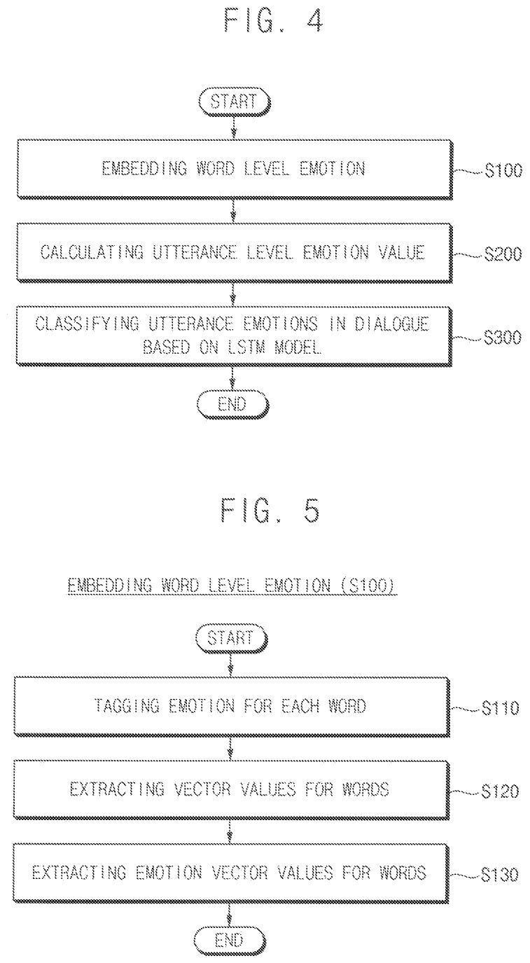

Next, the flowchart of FIG. 4 shows a method for classifying emotions of utterances in dialogue using the semi-supervised learning-based word-level emotion embedding and the LSTM model according to an exemplary embodiment of the present invention.

Referring to FIG. 4, the method for classifying emotions of utterances in dialogue using the semi-supervised learning-based word-level emotion embedding and the LSTM model may include the steps of embedding a word-level emotion S100, extracting an utterance-level emotion value S200, and classifying emotions of utterances in a dialogue based on LSTM model S300.

In the word-level emotion embedding step S100, the server computer device 200 inputs dialogue data provided from the communication terminal 130 functioning as the client computer device 100 into the word-level emotion embedding unit 230 to perform the word-level emotion embedding. For the word-level emotion embedding, emotion may be tagged for each word in the utterance with reference to the word-emotion association lexicon 240. To this end, as mentioned above, basic human emotions may be tagged for each word for learning in the word-emotion association lexicon 240. In order to extract a meaningful value of the emotion of the word, the output of the word-emotion association lexicon 240 may be provided to the embedding unit 250 to extract a vector value for the word. This is a step of extracting a vector value through performing a weight operation on the emotion value of the extracted word by using the vector value of the extracted word.

The utterance-level emotion value extraction step S200 may be a step of extracting an emotion vector value corresponding to the utterance by performing a sum operation on emotion vector values corresponding to words in the utterance.

In the step of classifying emotions of utterances in a dialogue based on the LSTM model S300, an emotion vector value of the utterance extracted in the utterance-level emotion value extraction step S200 may be used as an input value of the LSTM model 260, and emotions of the utterances may be classified in consideration of the change of emotion within the dialogue through the LSTM model.

The flowchart of FIG. 5 shows in detail a specific method of performing the word-level emotion embedding step S100 of FIG. 2 according to an exemplary embodiment of the present invention.

Referring to FIG. 5, the word-level emotion embedding step S100 according to an exemplary embodiment may include the steps of tagging an emotion for each word S110, extracting vector values for words S120, and extracting emotion vector values for words S130.

In the step of tagging an emotion for each word S110 according to an exemplary embodiment, the emotion value of each word in the utterance made of natural language may be tagged using the word-emotion association lexicon 240, and data may be constructed for learning word-level emotion embedding. Even the same word has different emotions depending on the utterance. To this end, it is considered that emotions of the surrounding words around a central word of the words in the utterance are the same as the emotion of the central word. In order to tag an emotion value on a word, the word-emotion association lexicon 240 in which six emotions, which are basic human emotions, may be tagged for each word is referred. When the central word does not correspond to the word-emotion association lexicon 240, emotions of surrounding words may not be tagged. For learning, data may be constructed by pairing a word and an emotion corresponding to the word.

The step of extracting vector values for words S120 according to the exemplary embodiment is a step to extract a meaningful value that the word has in a dialogue. In order to extract the meaningful vector value of a word, a weight operation may be performed on the word vector expressed by one-hot encoding and a weight matrix. A vector value encoded through the weight operation may be considered as a meaningful vector value of a word.

The step of extracting emotion vector values for words S130 according to the exemplary embodiment is to extract a meaningful value of the emotion of the word in the utterance. In order to extract a meaningful emotion vector value for the word, a weight operation may be performed on the vector value and the weight matrix encoded in the step of extracting vector values for words S120. The value of the weight matrix may be adjusted by comparing the vector value extracted through the weight operation with the expected emotion value (that is, a real emotion value (correct emotion value) of the original word).

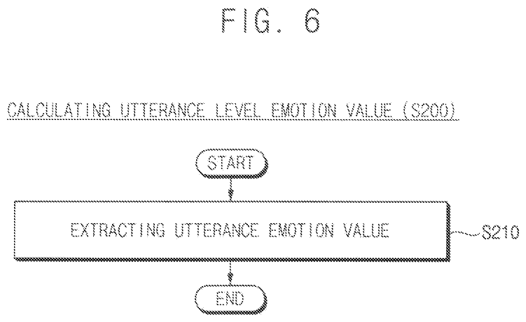

Next, the flowchart of FIG. 6 shows in detail a specific method of performing the utterance-level emotion value extraction step S200 according to an exemplary embodiment of the present invention.

Referring to FIG. 6, the step S200 may include a step of extracting an emotion value of the utterance S210 according to an exemplary embodiment.

In the step of extracting an emotion value of the utterance S210 according to an exemplary embodiment, a word-level emotion vector value may be extracted through word-level emotion embedding for the words constituting the utterance, and an emotion value of the utterance may be extracted by summing the extracted emotion vector values. In the step of extracting an emotion value of the utterance S210, the emotion vector values for the words in the utterance may be obtained as the emotion value of the utterance through the sum operation.

Next, FIG. 7 illustrates a method of classifying emotions of utterances in a dialogue based on the single layer LSTM model 260 according to an exemplary embodiment of the present invention.

The step of classifying emotions of utterances in a dialogue based on LSTM model S300 shown in FIG. 4 will be described with reference to FIG. 7.

The step of classifying emotions of utterances in a dialogue based on LSTM model S300 is a step to classify utterance emotions by using the LSTM model 260 in consideration of changes in emotion occurring in the dialogue. A single-layer LSTM model 260 may be used for the emotion classification. One dialogue may include several utterances. Accordingly, an input fed into the LSTM model 260 may be emotion values of the utterances in the dialogue extracted in the utterance-level emotion value extraction step S200 as expressed by Equation (3). A comparison operation may be performed to compare the value output from the LSTM model 260 with the emotion value which should be expected by the softmax function. Through this operation, it is possible to classify emotions of utterances in consideration of the change of emotion occurring in the dialogue.

As described above, the present invention can provide a source technology for appropriately classifying emotions of utterances by recognizing the change of emotion in a dialogue made in natural language using semi-supervised learning-based word-level emotion embedding and the LSTM model. As can be expected from the above description, the method to classify the emotion of utterance in a dialogue using the semi-supervised learning-based word-level emotion embedding and the LSTM model may be implemented as a computer program. And the computer program may be made into an executable file(s) and can be executed by a processor of a computer device. That is, each step of the method may be performed by the processor executing a sequence of instructions of the computer program.

The apparatus described above may be implemented as hardware components, software components, and/or combination of the hardware components and the software components. For example, devices and components described in the embodiments may be implemented using one or more general purpose or special purpose computers, such as a processor, a controller, an arithmetic logic unit (ALU), a digital signal processor, a microcomputer, a field programmable array (FPA), a programmable logic unit (PLU), microprocessor, or any other device capable of executing and responding to instructions. The processing device may execute an operating system (OS) and one or more software applications running on the OS. The processing device may also access, store, manipulate, process, and generate data in response to execution of the software. For convenience of understanding, although one processing device is sometimes described as being used, one of ordinary skill in the art will recognize that the processing device includes a plurality of processing elements and/or a plurality of types of processing elements. For example, the processing device may include a plurality of processors or one processor and one controller. Other processing configurations are also possible, such as parallel processors.

Software may comprise a computer program, code, instructions, or a combination of one or more thereof. The software may configure the processing device to operate as desired, or independently or collectively instruct the processing device to operate. Software and/or data may be permanently or temporarily embodied in any type of machine, component, physical device, virtual equipment, computer storage medium or device, or transmitted signal wave in order to be interpreted by the processing unit or to provide instructions or data to the processing device. The software may be distributed over networked computer systems, and stored or executed in a distributed manner. Software and data may be stored in one or more computer-readable recording media.

According to various embodiments of the present invention, the method described above may be realized in a form of program instructions executable through various computer devices and recorded in a computer-readable medium. The computer-readable medium may include program instructions, data files, data structures, and the like, alone or in combination. The program instructions recorded in the medium may be those specially designed and configured for the embodiments, or may be widely known and available to those skilled in the art of computer software. Examples of the computer-readable medium include: magnetic media such as hard disks, floppy disks, and magnetic tapes; optical media such as CD-ROMs and DVDs; magneto-optical media such as floptical disks; and hardware devices specifically configured to store and execute program instructions, such as ROMs, RAMs, and flash memory. Examples of the program instructions include machine language codes such as those generated by a compiler, as well as high-level language codes executable by a computer by using an interpreter or the like. The hardware devices described above may be configured to operate as one or more software modules to execute the operations of the embodiments, and vice versa.

### INDUSTRIAL APPLICABILITY

The present invention can be used in various ways in the field of natural language processing. In particular, since the present invention can classify emotions of utterance appropriately by recognizing a change in emotion in a natural language dialogue, it can be useful in application fields requiring the functional ability.

Features, structures, effects, etc. described in the above embodiments are included in one embodiment of the present invention, and are not necessarily limited to one embodiment. Furthermore, features, structures, effects, etc. illustrated in each embodiment can be combined or modified for other embodiments by those of ordinary skill in the art to which the embodiments belong. Accordingly, the contents related to such combinations and modifications should be interpreted as being included in the scope of the present invention.

In addition, the present invention has been described focusing on the embodiments in the above, but those are merely examples and do not limit the present invention. Those of ordinary skill in the art to which the present invention pertains may make various modifications and applications not illustrated above within a range that does not depart from the essential characteristics of the embodiments. For example, each element specifically shown in the embodiment may be implemented by modification. And differences related to such modifications and applications should be construed as being included in the scope of the present invention defined in the appended claims.

1. A method of classifying emotions of utterances in a dialogue using word-level emotion embedding based on semi-supervised learning and a long short-term memory (LSTM) model, being implanted as a computer readable program and executable by a processor of a computing apparatus, comprising:
embedding, in the computing apparatus, word-level emotion by tagging an emotion for each of words in utterances of input dialogue data with reference to a word-emotion association lexicon in which basic emotions are tagged for words for learning;
extracting, in the computing apparatus, an emotion value of the utterances input; and
classifying, in the computing apparatus, emotions of the utterances in consideration of change of emotion in the dialogue made in a messenger client, based on the LSTM model, using extracted emotion values of the utterances as input values of the LSTM model.

2. The method of claim 1, wherein the embedding word-level emotion comprises: tagging an emotion value of each word in the utterances made of natural language with reference to the word-emotion association lexicon, to construct data with a lot of a pair of a word and an emotion corresponding to the word for learning word-level emotion embedding; extracting a meaningful vector value that a word has in a the dialogue; and extracting a meaningful emotion vector value that the word has in an utterance.

3. The method of claim 2, wherein the word-emotion association lexicon includes six emotions as the basic emotion: anger, fear, disgust, happiness, sadness, and surprise.

4. The method of claim 2, wherein the meaningful vector value of the word is an encoded vector value obtained by performing a weight operation on a word vector expressed by one-hot encoding and a weight matrix.

5. The method of claim 4, wherein the ‘meaningful emotion vector value of the word’ is obtained by performing a weight operation on the vector value encoded in extracting a vector value for the word and a weight matrix, and a value of the weight matrix is adjusted by comparing a vector value extracted through the weight operation with an emotion value to be expected.

6. The method of claim 1, wherein the ‘extracting an emotion value of the utterances input’ is to extract word-level emotion vector value through word-level emotion embedding for words constituting the utterances, and calculate an emotion value of the utterances by summing the extracted values.

7. The method of claim 1, wherein the ‘classifying emotions of the utterances in consideration of change of emotion in the dialogue’ is to classify the emotions of utterances in the dialogue by using a sum of the emotion values of the utterances in the dialogue extracted in the extracting an utterance-level emotion value as an input to the LSTM model, and perform a comparison operation between values output from the LSTM model and an emotion value to be expected through a softmax function.

8. The method of claim 1, wherein the input dialogue data is data input to the computing apparatus acting as a server computer through the messenger client generated by a client computing apparatus.

9. A computer-readable recording medium in which a computer program is recorded for performing the method of classifying emotions of utterances in a dialogue using word-level emotion embedding based on semi-supervised learning and a LSTM model according to claim 1.

10. A computer-executable program stored in a computer-readable recording medium to perform the method of classifying emotions of utterances in a dialogue using word-level emotion embedding based on semi-supervised learning and a LSTM model according to claim 1.
